(19) United States
(12) Patent Application Publication
(10) Pub. No.: US 2003/0176098 A1
(43) Pub. Date: Sep. 18, 2003

(54) Insulation piercing connecting device

(76) Inventors: Wofgang Brandl, Amberg (DE); Peter Donhauser, Amberg (DE); Alfred Fischer, Schwandorf (DE); Ludwig Niebler, Laaber (DE)

Correspondence Address: HARNESS, DICKEY & PIERCE, P.L.C., P.O.BOX 8910, RESTON, VA, 20195, US

(21) Appl. No.: 10/344,753

(22) PCT Filed: Aug. 3, 2001
(86) PCT No.: PCT/DE01/02975

(30) Foreign Application Priority Data
Aug. 16, 2000 (DE) 100 39 963.0

(51) Int. Cl. H01R 4/24; H01R 4/26; H01R 11/20

(52) U.S. Cl. 439/391; 439/409; 439/393

(57) ABSTRACT

An insulation piercing connector (2) is held inside a base body (1), and a closing element (3) is guided inside said base body. The closing element can be transferred into a closed position at least from one open position, in which a conductor (4) can be inserted into the closing element (3). By transferring the closing element (3) into the closed position, the conductor (4)can be inserted into the insulation piercing connector (2) and can be held and clamped therein. An over spring (7) is arranged on the closing element (3). Said over spring surrounds the insulation piercing connector (2) and contacts the same via contact pieces (8) whereby exerting a pressure force (F) onto the insulation piercing connector (2).

The present invention relates to an insulation piercing connecting device with a base body, an insulation piercing connector which is held in the base body and a closing element which is guided by the base body and can be transferred at least from one open position into a closed position, it being possible in the open position for a conductor to be inserted into the closing element and it being possible by transferring the closing element into the closed position for a conductor which has been inserted into the closing element to be inserted into the insulation piercing connector and held and clamped by the insulation piercing connector, the insulation piercing connector being surrounded by an overspring which contacts the insulation piercing connector with contact pieces and thereby exerts a pressing force on the insulation piercing connector.

An insulation piercing connecting device of this type is known for example from DE 197 32 182 C1. On it, the overspring is rigidly connected to the insulation piercing connector.

The object of the present invention is to provide an improved insulation piercing connecting device.

The object is achieved by the overspring being arranged on the closing element, so that in the open position the contact pieces contact the insulation piercing connector in opening contact regions and in the closed position they contact it in closing contact regions.

This is because it is made possible in this way to vary the action of the overspring on the insulation piercing connector.

If the closing element and the overspring are integrally connected to each other, the insulation piercing connecting device is constructed in a particularly simple form.

If the closing element and the overspring are formed as a punched/bent part, the production of the closing element and the overspring is particularly simple.

The actuation of the closing element is possible particularly easily if a bearing element for an actuating tool is formed onto the closing element. In this case, the bearing element is preferably also a component part of the punched/bent part.

If the insulation piercing connector between the opening contact regions and the closing contact regions is formed in such a way that the pressing force varies when the closing element is transferred from the open position into the closed position, the exertion of force onto the insulation piercing connector can be adapted to the respective position of the closing element between the open position and the closed position.

If the insulation piercing connector in the opening contact regions and/or the closing contact regions and the contact pieces are formed in such a way that the pressing force is minimal in the open position and/or the closed position, the open position and/or the closed position form preferential positions. Consequently, reaching them can be sensed by tactile means. Minimizing the pressing force can be achieved, for example, by the insulation piercing connector being narrowed in a curved manner in the opening contact regions and/or the closing contact regions. The contact pieces are preferably narrowed in a way which corresponds thereto.

Further advantages and details emerge from the following description of an exemplary embodiment in conjunction with the drawings, which constitute a basic representation and in which:

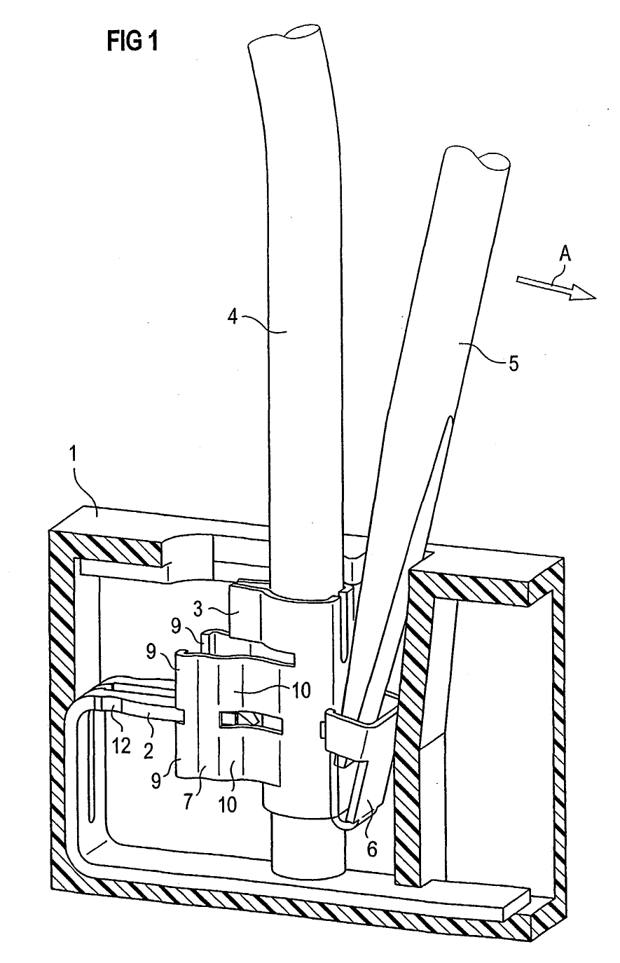

FIG. 1 shows an insulation piercing connecting device with a closing. element, conductor and operating tool and

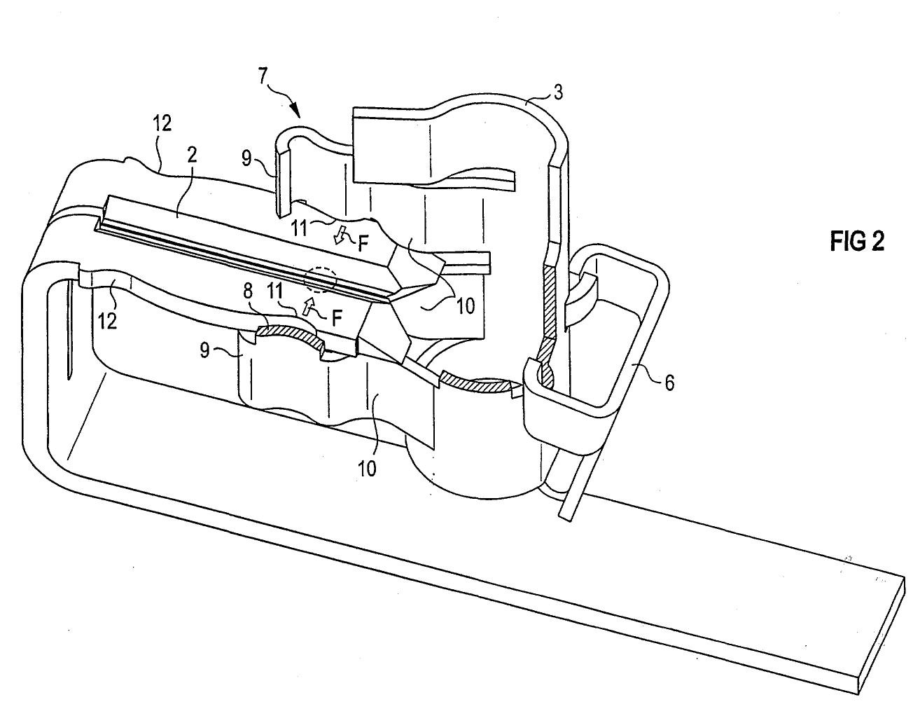

FIG. 2 shows an insulation piercing connector with a closing element.

According to FIG. 1, an insulation piercing connecting device has a base body 1. Held in the base body 1 is an insulation piercing connector 2. The insulation piercing connecting device also has a closing element 3. In FIGS. 1 and 2, the closing element 3 is represented in an open position. In the open position, a single-core conductor 4, which does not have to be stripped, can be inserted into the closing element 3.

The closing element 3 can be transferred from the open position into a closed position. For this purpose, an actuating tool 5, generally a customary screwdriver, is inserted into a bearing element 6, which is formed onto the closing element 3. By pivoting the actuating tool 5 in an actuating direction A, the closing element 3 is then transferred into the closed position. The conductor 4 is thereby inserted into the insulation piercing connector 2 and is held and clamped by the latter in the closed position. The position of the conductor 4 in the closed position is symbolized in FIG. 2 by a circle indicated by dashed lines.

Arranged on the closing element 3 is an overspring 7, which surrounds the insulation piercing connector 2. The overspring 7 thereby contacts the insulation piercing connector 2 with contact pieces 8 and therefore exerts a pressing force F on the insulation piercing connector 2. On account of the way in which the overspring 7 is formed, in particular on account of the presence of front wrap-around lugs 9 and rear wraparound lugs 10, the overspring 7 thereby forms at the same time a guiding element, on account of which the closing element 3 is guided with respect to the insulation piercing connector 2 and consequently ultimately also in the base body 1.

On account of the arrangement of the overspring 7 on the closing element 3, the overspring 7 is moved together with the closing element 3. In the open position of the closing element 3, the contact pieces 8 therefore contact the insulation piercing connector in opening contact regions 11, in the closed position they contact it in closing contact regions 12. It is evident here that the closing element 3 and the overspring 7 are integrally connected to each other. In particular, the closing element 3, the bearing element 6 and the overspring 7 are formed as an (integral) punched/bent part.

According to FIG. 2, the insulation piercing connector 2 is narrowed in a curved manner in the opening contact regions 11 and closing contact regions 12. The contact pieces 8 are also narrowed in a curved manner corresponding thereto. This way of forming the insulation piercing connector 2 and the overspring 7 achieves the effect that the pressing force F in these two positions is minimal. Consequently, preferential positions are produced, the reaching of which can be sensed by tactile means.

Between the open position and the closed position, on the other hand, the insulation piercing connector 2 is widened in a convex manner. As a result, when the closing element 3 is transferred from the open position into the closed position, the pressing force F is varied according to the convex profile of the insulation piercing connector 2.

With the insulation piercing connecting device according to the invention, a series of advantages can be achieved. In particular, the pressing force F can be adapted to the individual process steps, and changed, when transferring from the open position into the closed position (firstly insertion and piercing of the insulation, then contacting of the conductor 4). It is consequently possible to realize a force characteristic which is optimized to the individual process steps and permits ergonomically favorable actuation. By minimizing the pressing force F in the two end positions of the clamping element 3, reaching these two positions can on the one hand be reliably brought about and on the other hand sensed by tactile means. As a result, both the actuating forces and the displacement distances can be reduced. Consequently, a relatively small overall volume of the insulation piercing connecting device is obtained. Finally, the insulation piercing connecting device according to the invention can also be used in a greater cross-sectional range than comparable insulation piercing connecting devices of the prior art.

1. An insulation piercing connecting device with a base body (1), an insulation piercing connector (2) which is held in the base body (1) and a closing element (3) which is guided in the base body (1) and can be transferred at least from one open position into a closed position, it being possible in the open position for a conductor (4) to be inserted into the closing element (3) and it being possible by transferring the closing element (3) into the closed position for a conductor (4) which has been inserted into the closing element (3) to be inserted into the insulation piercing connector (2) and held and clamped by the insulation piercing connector (2), the insulation piercing connector (2) being surrounded by an overspring (7) which contacts the insulation piercing connector (2) with contact pieces (8) and thereby exerts a pressing force (F) on the insulation piercing connector (2), characterized in that the overspring (7) is arranged on the closing element (3), so that in the open position the contact pieces (8) contact the insulation piercing connector (2) in opening contact regions (11) and in the closed position they contact it in closing contact regions (12).

2. The insulation piercing connecting device as claimed in claim 1, characterized in that the closing element (3) and the overspring (7) are integrally connected to each other.

3. The insulation piercing connecting device as claimed in claim 2, characterized in that the closing element (3) and the overspring (7) are formed as a punched/bent part.

4. The insulation piercing connecting device as claimed in claim 2 or 3, characterized in that a bearing element (6) for an actuating tool (5) is formed onto the closing element (3).

5. The insulation piercing connecting device as claimed in claims 3 and 4, characterized in that the bearing element (6) is also a component part of the punched/bent part.

6. The insulation piercing connecting device one of the above claims, characterized in that the insulation piercing connector (2) between the opening contact regions (11) and the closing contact regions (12) is formed in such a way that the pressing force (F) varies when the closing element (3) is transferred from the open position into the closed position.

7. The insulation piercing connecting device as claimed in one of the above claims, characterized in that the insulation piercing connector (2) in the opening contact regions (11) and/or the closing contact regions (12) and the contact pieces (8) are formed in such a way that the pressing force (F). is minimal in the open position and/or the closed position.

8. The insulation piercing connecting device as claimed in claim 7, characterized in that the insulation piercing connector (2) is narrowed in a curved manner in the opening contact regions (11) and/or the closing contact regions (12).

9. The insulation piercing connecting device as claimed in claim 8, characterized in that the contact pieces (8) are correspondingly narrowed in a curved manner.
